(19) United States
(12) Patent Application Publication
(10) Pub. No.: US 2007/0277414 A1
(43) Pub. Date: Dec. 6, 2007

(54) Structure for conveying information to an observer

(76) Inventor: Craig Thomas Canon, Lakewood, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/447,342

(22) Filed: Jun. 5, 2006

(51) Int. Cl. G09F 7/00

(52) U.S. Cl. 40/612

(57) ABSTRACT

A stick figure structure for conveying information to observer of the structure. The stick figure structure may have a torso member, left and right leg members, left and right arm members, and a head member configured to resemble a stick figure. The stick figure structure's members may be further configured to convey information to observers. The stick figure structure may support a sign or a banner. One or more stick figure structures may be located along a route to convey direction information to observers of the structures. Two or more stick figure structures may be arranged to jointly support a sign or a banner or to form a barricade.

### CROSS-REFERENCE TO RELATED APPLICATIONS

This application is related to U.S. Design Application No. 29/______ entitled “STRUCTURE FOR SUPPORTING SIGNS AND FORMING BARRIERS,” naming Craig Thomas Canon as an inventor, and filed on Jun. 5, 2006, with Express Mail Label No. EV 759 037 937 US.

### BACKGROUND OF THE INVENTION

a. Field of the Invention

This invention relates to structures for conveying information to an observer of the structures and for supporting signs conveying information to an observer of the sign.

b. Background Art

Participants of a bicycling event such as a bicycle race or bicycle fun ride often ride along a pre-determined route. The route may cross road intersections and other points that require a decision about which direction to proceed. Accordingly, maps may be provided to the participants to inform them the proper direction to proceed as they reach directional decision points along the route. Although maps are useful to convey route information, maps require the participant to either memorize the route or to undesirably refer to the map while riding along the route.

One potential way to address the shortcomings of a map may be to post signs along the route that indicate the direction to proceed. However, a sign may need to be relatively large to provide information to a participant at a distance from it. Further, the sign often requires a support structure to ensure the sign remains visible to the participants. A support structure may also be required to locate the sign at a sufficient elevation to be readily observable by the participant. Adequate support structures may or may not be available along the route. Further, as a sign's size increases, the size required for the support structure usually increases, therefore potentially limiting the number of suitable supports for the sign along the route. When adequate support structures for a sign are not located along the route, the support structures must be provided.

Another potential way to address the shortcomings of a map may be to chalk or paint the road along the route to indicate the direction to proceed. Chalking and painting the road may involve significant effort, especially for a long course. Chalking and painting the road may also require the road to be closed to safely chalk or paint it. If the road is not closed, individuals chalking and painting the road may be at risk of being hit by an automobile or other vehicle. Further, chalk may be washed away before or during the event, while paint may not be permitted or may require significant effort to remove after the event.

Yet another potential way to address the shortcomings of a map may be to have volunteers stand along to the route to provide directions to participants. For many events, there may not be enough volunteers to cover the route. Further, volunteers standing along the route are exposed to the risk of being hit or struck by a bicycle or a vehicle, especially when roads intersecting the route are not closed to vehicles.

Issues regarding directions similar to those for participants of a cycling event may arise for individuals (spectators, participants, etc.) attempting to find parking or other areas associated with a certain event or activity (e.g., a bicycle race, a soccer tournament, etc.). This may be especially true when the individuals are not familiar with the area. Some of the ways that address providing route information to participants of a cycling event (e.g., maps, signs, etc.) may be used to provide direction information to those attempting to locate areas associated with a certain event. However, these ways often suffer from the same or similar issues identified above with respect to providing bicycle route information to cyclists.

Yet another issue may arise when a driver of a vehicle unexpectedly comes upon the event. Often, event promoters are focused on providing route directions to the participants of the cycling event in the form of small, handwritten signs and spray painting on the road arrows for direction and circles around hazards. Further, promoters often do not budget for signs alerting vehicles that an event is occurring in the area. Thus, vehicles may come across an event without realizing the event is occurring. Moreover, no directions or other information is provided about how to get around or avoid the event. The lack of signage or other information raising awareness that an event is occurring and/or providing information about how to avoid the event creates a potentially dangerous situation for the cyclists participating in the event as vehicles may unexpectedly encounter the event without an awareness that numerous cyclists are around, or end up on or crossing the course since they have no information about how to proceed to avoid the event.

One potential way to raise awareness that an event is occurring in a certain geographical area is to advertise to the general public in the form of newspapers, radio and posted flyers. These forms of advertisement are often expensive. Further, this type of advertising is often not done since event promoters generally prefer to spend their limited budgets on attracting more participants. Further, these forms of advertisement may have limited effectiveness as they typically reach only a segment of the general public and require those who do receive the message to remember information such as the event, location, date, and so on.

One potential way to provide directions to avoid the event is to use signs to indicate detours around the event. However, as mentioned above, promoters often do not budget for these type of signs. Moreover, these signs also suffer from similar issues as the signs used to inform participants about route directions.

Accordingly, what is need in the art is an improved device or method for conveying information to an observer of the device such as a participant or spectator of an event or a vehicle driver unaware of the event.

### BRIEF SUMMARY OF THE INVENTION

One example of the present invention takes the form of a structure for conveying information about a specific event or activity to an observer of the structure. The structure includes a torso member with a first end portion and a second end portion, a head member joined with the torso member near the first end portion of the torso member, at least one arm member joined with the torso member between the first and second end portions of the torso member, and at least one leg member joined with the torso member near the second end portion of the torso member. The at least one leg member extends from the torso member, and the at least one arm member extends from the torso member. The head member is an object related to the specific event or activity. The head member, the torso member, the at least one arm member, and the at least one leg member are configured to resemble a stick figure.

Another example of the present invention takes the form of a method of conveying information about a route associated with an event. The method includes providing at least one first structure, locating the at least one first structure along the route associated with the event; and configuring the at least one structures to indicate a direction to proceed along the route. The at least one structure includes a torso member with a first end portion and a second end portion, a head member related to the specific event and joined with the torso member near the first end portion of the torso member, at least one arm member joined with the torso member between the first and second end portions of the torso member and extending from the torso member; and at least one leg member joined with the torso member near the second end portion of the torso member and extending from the torso member. The head member, the torso member, the at least one arm member, and the at least one leg member are configured to resemble a stick figure.

Yet another example of the present invention takes the forming a barrier for an event of activity. The method includes providing a plurality of structures and arranging the plurality of structures in a line. Each structures includes a torso member with a first end portion and a second end portion, a head member related to the specific event or activity and joined with the torso member near the first end portion of the torso member, two arm members joined with the torso member between the first and second end portions of the torso member with each arm member extending from the torso member and each arm member including a free end representing a location of a hand, at least one leg member joined with the torso member near the second end portion of the torso member and extending from the torso member, and the head member, the torso member, the two arms member, and the at least one leg member configured to resemble a stick figure. The plurality of structures appear to join hands.

### BRIEF DESCRIPTION OF THE DRAWINGS

FIG. 1 depicts a front perspective view of a first example of a stick figure structure.

FIG. 2 depicts a front elevation view of the stick figure structure depicted in FIG. 1.

FIG. 3 depicts a perspective view of an arm connection assembly for joining an arm member to a torso member for the stick figure structure depicted in FIG. 1.

FIG. 4 depicts a perspective view of another arm connection assembly for joining arm segments together for the stick figure structure depicted in FIG. 1.

FIG. 5 depicts a perspective view of a leg connection assembly for joining leg members to the torso member for the stick figure structure depicted in FIG. 1.

FIG. 6 depicts a cross-section view of leg and torso members of the stick figure structure depicted in FIG. 1, viewed along line 6-6 in FIG. 2.

FIG. 7 depicts a cross-sectional view of arm members of the stick figure structure depicted in FIG. 1, viewed along line 7-7 in FIG. 2

FIG. 8 depicts a perspective view of a stick figure structure configured to inform an observer of the structure to turn right at an intersection.

FIG. 9A depicts a schematic view of stick figure structures arranged along a route to convey directional information regarding the route to observers of the stick figure structures.

FIG. 9B depicts another schematic view of stick figure structures arranged along a route to convey directional information regarding the route to observers.

FIGS. 10A-K depict simple front elevation views showing stick figure structures, each structure configured in a certain manner to convey information to an observer of the structure.

FIGS. 11A-I depict simple front elevation views showing one or more stick figure structures, each structure or structures configured and/or arranged in a certain manner to support a sign or other object conveying written or symbolic information to an observer of the structure or structures.

FIG. 12 depicts a front elevation view of a stick figure structure supporting a sign or other object conveying written or symbolic information to an observer of the sign.

FIG. 13 depicts a front perspective view of a stick figure structure with an object resembling a soccer ball for the head member.

FIG. 14 depicts a front perspective view of a stick figure structure with an object resembling a football for the head member.

FIG. 15 depicts a front perspective view of a stick figure structure with an object resembling a basketball for the head member.

FIG. 16 depicts a front perspective view of a stick figure structure with an object resembling a tennis ball for the head member.

FIG. 17 depicts a front perspective view of a stick figure structure with an object resembling a baseball or a softball for the head member.

FIG. 18 depicts a front perspective view of a stick figure structure with an object resembling a hockey puck for the head member.

FIG. 19 depicts a front perspective view of a stick figure structure with an object resembling a golf ball for the head member.

FIG. 20 depicts a front perspective view of a stick figure structure with an object resembling a ball for the head member.

FIG. 21 depicts a front perspective view of a stick figure structure with an object resembling a globe for the head member.

FIG. 22 depicts a front perspective view of a stick figure structure with an object resembling an animal caricature for the head member.

FIG. 23 depicts a front perspective view of a stick figure structure with an object resembling a male head for the head member.

FIG. 24 depicts a front perspective view of a stick figure structure with an object resembling a female head for the head member.

### DETAILED DESCRIPTION OF THE INVENTION

Described herein are structures that may take the form of stick figures for use in conveying information to observers of the structures about an event such as a bicycle race or tour, soccer tournament, basketball game or tournament, tennis tournament, baseball game or tournament, softball game or tournament, golf tournament, football game or event, hockey game or tournament, political rally or convention, and so on, or of an activity such as bicycling, soccer, basketball, tennis, baseball, golf, football, and so on. The stick figure structures may include a head member, a torso member, left and right arm members, and left and right leg members configured to resemble a stick figure. One or more of these members may be further configured to convey information to an observer of the structure. Further, the head member may be or resemble an object related to the event or activity such as a bicycle wheel, a soccer ball, basketball, a tennis ball, a baseball, a golf ball, and so on. The stick figure structures may also include left and right base members joined to left and right leg members respectively to anchor the stick figure structures to a support surface such as the pavement or the ground. One or more stick figure structures may be configured and arranged to support one or more signs, banners, or the like.

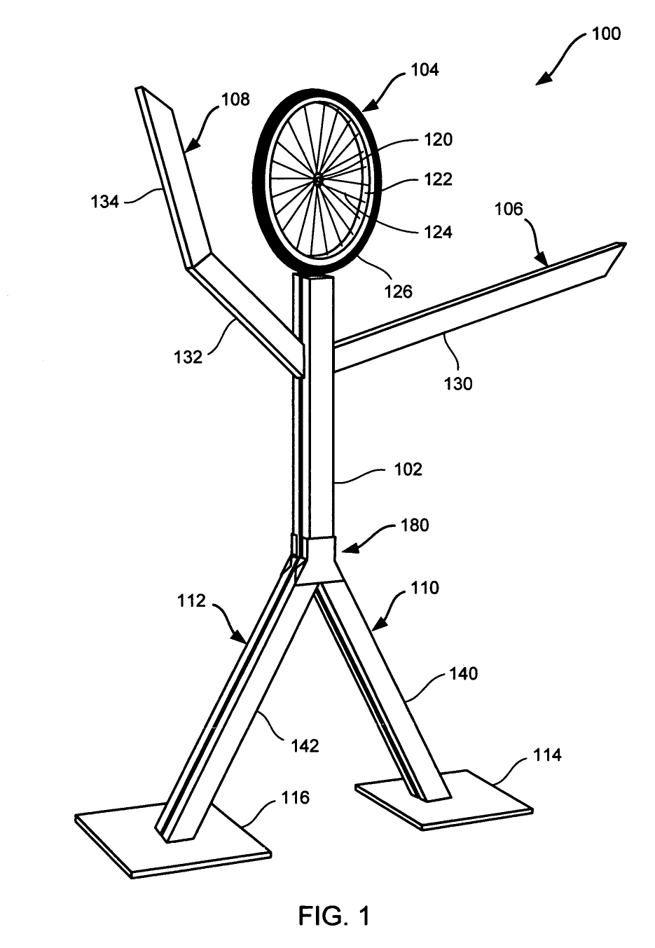

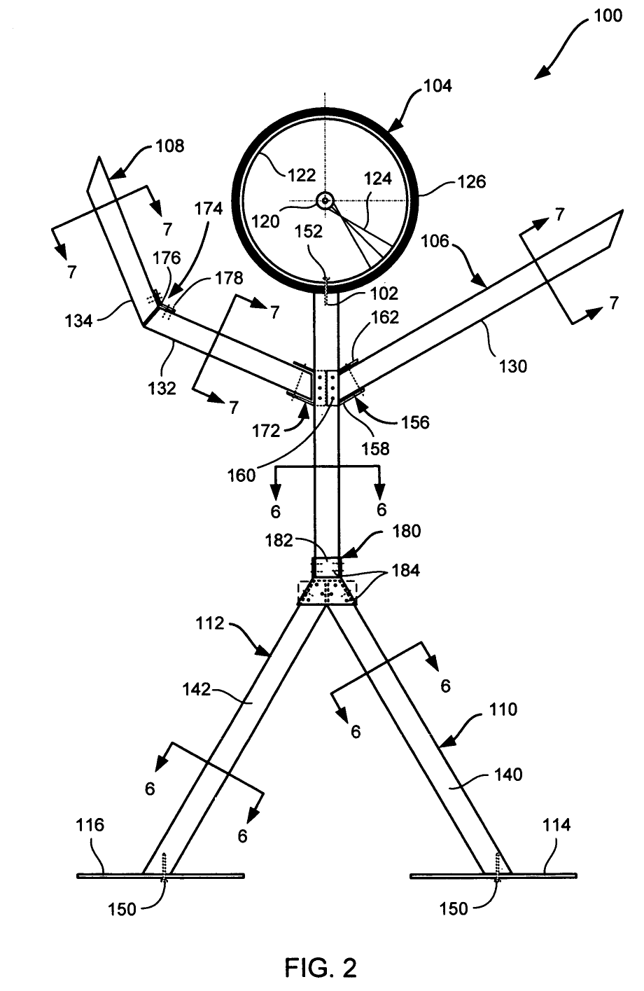

With reference to FIGS. 1 and 2, one example of a stick figure structure 100 includes an elongated torso member 102 having upper and lower end portions. A head member 104 is joined to the torso member 102 near its upper end portion, left and right arm members 106, 108 are joined to the torso member 102 between its upper and lower end portions, and left and right leg members 110, 112 are joined to the torso member 102 near its lower end portion. Together, the torso member 102, the head member 104, the arm members 106, 108, and the leg members 110, 112 resemble a stick figure. More particularly, the torso, head, arm, and leg members 102, 104, 106, 108, 110, 112 are shaped and arranged to form a three-dimensional structure that somewhat resembles a simplified drawing of a human being created using straight lines and circles, which is commonly known as a stick figure. Left and right base members 114, 116 may be joined to the left and right leg members 110, 112 respectively to anchor the stick figure structure 100 to a support surface.

Shaping and configuring the head, arm and leg members 104, 106, 108, 110, 112 to resemble a stick figure enable the arm and leg members 106, 108, 110, 112 to be further configured to convey information to an observer of the stick figure structure 100 in a manner similar to how a person conveys non-verbal and non-written information to other people using the person's arms and legs. For example, one or both of the stick figure structure's arm members 106, 108 may be arranged to point in a certain direction to convey information to observers of the stick figure structure 100 about a direction to proceed similar to a person directing traffic using the person's arms to point to a direction to proceed. As another example, one or both of the stick figure structure's arm members 106, 108 may be arranged with an upper portion extending forward from the torso member 102 and a lower portion extending generally vertically upward to indicate to observers of the stick figure structure 100 to stop in a manner similar to a person directing traffic holding the person's arm in front of them with their wrist extending upward to indicate that traffic should stop.

Shaping and configuring the head, arm, and leg members 104, 106, 108, 110, 112 to resemble a stick figure also results in a relatively easy structure to design and build. Further, the relatively small depths and widths of the torso, arm and leg members 102, 106, 108, 110, 112 relative to the lengths of these members 102, 106, 108, 110, 112 result in a relatively small surface area for the stick figure structure 100, which helps minimize the risk of an upright standing stick figure structure 100 falling over when it is windy.

The head member 104 may be a bicycle wheel or any other generally circular, spherical, or other shaped object that may represent a head. As described in more detail below, the object selected for the head member 104 may relate to a specific event or activity. The bicycle wheel may include a bicycle wheel hub 120 joined to a bicycle wheel rim 122 by bicycle wheel spokes 124. More or less bicycle wheels spokes 124 than the number depicted in FIG. 1 may be used to join the bicycle wheel hub 120 to the bicycle wheel rim 122. The size and shape of the bicycle wheels spokes 124 may also be different than the size and shaped depicted in FIG. 1. A bicycle tire 126 may generally encompass an outer surface of the bicycle wheel rim 122. If desired, a solid bicycle wheel may be used rather than a bicycle wheel with spokes as depicted in FIG. 1. However, using a bicycle wheel with one or more open areas between the bicycle wheel hub 120 and bicycle wheel rim 122 may generally reduce the potential for wind to overturn the stick figure structure 100.

As depicted in FIGS. 1 and 2, the left arm member 106 may include an elongated left arm segment 130, and the right arm member 108 may include two elongated right arm segments, an upper right arm segment 132 joined to the torso member 102 and a lower right arm segment 134 joined to the upper right arm segment 132. However, each arm member 106, 108 may include more or less segments than depicted in FIGS. 1 and 2. The left arm segment 130 may extend from the left side of the torso member 102 in a generally upwardly sloping direction as depicted in FIGS. 1 and 2 or in any other suitable direction. The upper right arm segment 132 may extend away from the torso member 102 in a generally upwardly sloping direction or in any other suitable direction, and the lower right arm segment 134 may extend away from the upper right arm segment 132 in a generally upwardly sloping direction or in any other suitable direction. As discussed in more detail below, the number of arm segments for the left and right arm members 106, 108 and the directions these arm segments extend away from the torso member 102 and each other may depend upon the information being conveyed to an observer of the stick figure structure 100, the intended function of the stick figure structure 100, or both.

The left leg member 110 may include one elongated left leg segment 140, and the right arm member 112 may include one elongated right leg segment 142. However, each leg member 110, 112 may include more or less leg segments than depicted in FIGS. 1 and 2. Each leg segment 140, 142 may extend from the torso member's lower end portion in a generally downwardly sloping direction as depicted in FIGS. 1 and 2 or in any other suitable direction. Together, the leg members 110, 112 and a support surface such as the ground may form a triangular base to support the weight of the torso, head, and arm members 102, 104, 106, 108 of the stick figure structure 100 when the stick figure structure 100 is set in an upright position as shown in FIGS. 1 and 2. As discussed in more detail below, the number of leg segments for the left and right legs members 110, 112 and the directions these leg segments extend away from the torso member 102, and each other, may depend upon the information being conveyed to an observer of the stick figure structure 100, the intended function of the stick figure structure 100, or both.

Left and right base members 114, 116 may be joined to the left and right leg members 110, 112, respectively, for anchoring the stick figure structure 100 and for spreading the weight of the stick figure structure 100 over a support surface. Each base member 114, 116 may have a generally rectangular planar area as depicted or any other suitable shape. Each base member 114, 116 may also have holes (not shown) for receiving anchor members (not shown) for anchoring each base member 114, 116 to the ground or other support surface. An anchor member may be an anchor bolt, a spike, or other suitable anchoring device. In lieu of or in combination with using anchor member, sandbags (not shown) or other suitable weights may be placed on the base members 114, 116 to anchor them to the ground or other support surface. Sandbags or other suitable weights may be useful when it is difficult or impractical to drive an anchor member into a support surface such as a concrete or asphalt road or pavement.

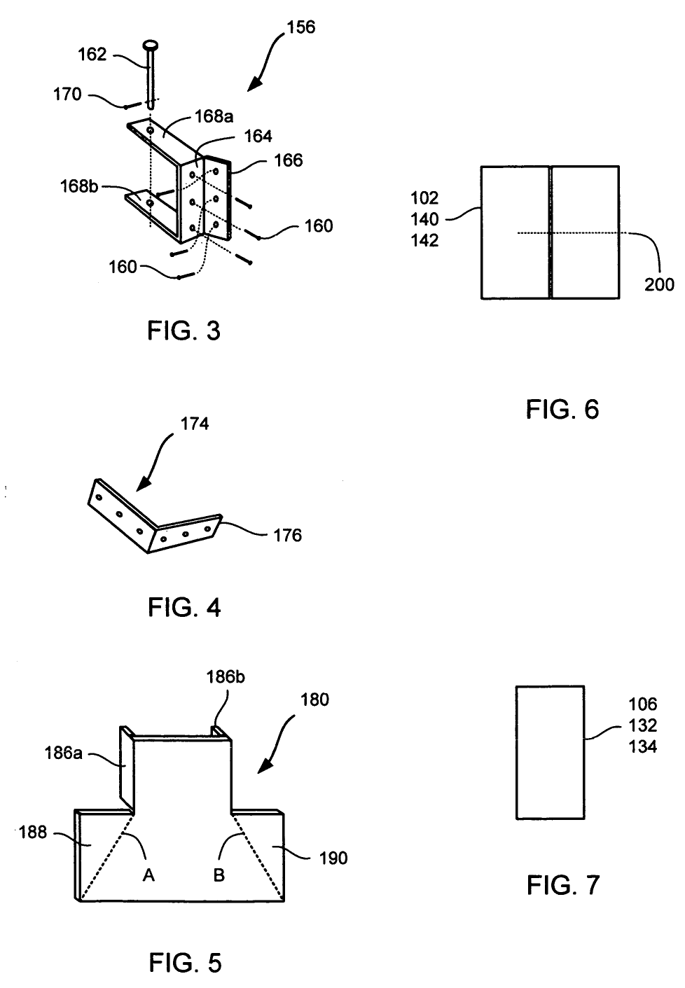

With reference to FIGS. 2, 3, 4, and 5, the right and left base members 114, 116 may be fixedly or releasably joined to the right and left leg members 110, 112 respectively using one or more base fasteners 150 such as screws, bolts, nails, pins, or the like. The head member 104 may be fixedly or releasably joined to the torso member's upper end portion using one or more head fasteners 152 such as screws, bolts, U-bolts, flexible straps, or the like. Further, the head member 104 may be joined to the torso member 102 so that it may pivot, rotate or spin relative to the torso member 102. For example, the torso member 102 may include a bearing for receiving a shaft of the head fastener 152 that allows the fastener 152 to rotate relative to the torso member 102 around the head fastener shaft's longitudinal axis. The fastener's rotation may then be transmitted to the head member 104, thereby causing the head member 104 to rotate relative to the torso member 102 around the head fastener shaft's longitudinal axis. As another example, the head fastener 152 may be an assembly of components that would join the head member 104 to the torso member 102 and allow a head member 104 such as a bicycle wheel or the like to rotate or spin, similar to a pinwheel, around a shaft received through a hole in the bicycle wheel hub 120.

The left arm segment 130 may be fixedly or releasably joined to the torso member 102 with a left arm connection assembly 156. The left arm connection assembly 156 may take the form of a quick release system, which allows for the left arm member 106 to be readily attached and detached from the torso member 102. It may be desirable to readily attach and detach both arm members 106, 108 since it is often easier to carry and transport the stick figure structure 100 to a desired location without the arm members 106, 108 attached. More particularly, with the arm members 106, 108 removed, the stick figure structure 100 is easier to carry since it weighs less and is easier to haul around since it occupies less overall space. Further, easy removal of the arm members 106, 108 allows for arm members 106, 108 with different configurations to be readily attached and detached from a generic torso and leg member configuration.

The left arm connection assembly 156 may include a left arm connection plate 158 with two or more holes for receiving two or more first left arm member connection fasteners such as nails, bolts, screws, pins, or the like, and a pair of generally aligned holes for receiving a second left arm member connection fasteners 162 such as a shaft, rod, bolt or the like. The left arm connection plate 158 may be configured so at least one first left arm member connection fastener 160 joins the left arm connection plate 158 to the torso member 102 and at least one second left arm connection fastener 162 joins the left arm connection plate 158 with the left arm segment 130, thereby joining the left arm member 106 to the torso member 102.

More particularly, the left arm connection plate 158 may include a generally C-shaped main section 164 for receiving an end portion of the left arm segment 130. Holes within the C-shaped section's web receive first left arm member connection fasteners 160 for joining the left arm connection plate 158 to the torso member 102 using the first left arm member connection fasteners 160. A web plate 166 may extend from the C-shaped main section's web. When the left arm segment 130 approximately abuts the torso member's left side, the web plate 166 may approximately abut the torso member's front side. Holes within the web plate 166 may also receive first left arm connection fasteners 160 that further join the left arm connection plate 158 to the torso member 102.

Holes with the C-shaped section's flanges 168 align with each other and a hole drilled through the left arm segment 130. The second left arm member connection fastener 162 is inserted through the aligned holes in the C-shapes section's flanges 168 and the left arm segment 130. The second left arm connection fastener 160 may contain one or more holes within it to receive a temporary locking mechanism 170 such as a cotter pin or the like to retain the second left arm member connection fastener 162 within the holes in the left arm connection plate 158 and the left arm segment 130. The temporary locking mechanism 170 allows the second left arm connection fastener 162 to be readily retained in and removed from the holes in the C-shaped section's flanges 168 and left arm segment 130, thereby allowing the left arm member 106 to be easily attached and detached from the torso member 102.

A right arm member connection assembly 172 similar to the left arm connection assembly 156 may join the upper right arm segment 132 to the torso member 102 in a manner similar to the one described above for joining the left arm segment 132 to the torso member 102. A right arm segment connection assembly 174 may fixedly or releasably join the upper right arm segment 132 to the lower right arm segment 134. The right arm segment connection assembly 174 may include a right arm segment connection plate 176 with two or more holes for receiving two or more right arm segment connection fasteners 178 such as nails, bolts, screws, pins, or the like. The right arm segment connection plate 176 may be configured so that at least one received right arm segment connection fastener 178 joins the right arm segment connection plate 176 to the upper right arm segment 134 and at least one other received right arm segment connection fastener 178 joins the right arm segment connection plate 176 with the lower right arm segment 134, thereby joining the upper and lower right arm segments 132, 134 together.

The left and right leg members 110,112 may be fixedly or releasably joined to the torso member's lower end portion with a leg member connection assembly 180. The leg member connection assembly 180 may include a leg connection plate 182 with three or more holes for receiving leg connection fasteners 184 such as nails, bolts, screws, pins, or the like. The leg connection plate 182 may be configured so that at least one received leg connection fastener 184 joins the leg connection plate 182 to the torso member 102 and at least two other received leg connection fasteners 184 (one for each leg member) join the leg connection plate 182 to the left and right leg members 110, 112. More particularly, the leg connection plate 182 may include a T-shaped main section with two opposing flanges 186 a-b extending from an upper portion of the T-shaped section. Holes (not shown) within the flanges 186 a-b may receive leg connection fasteners 184 for joining the leg connection plate 182 to the torso member 102. When the leg connection plate 182 is joined with the torso member 102, the T-shaped section's lower portion may abut the left and right leg members' front sides. Holes within the T-shaped section's lower portion may receive leg connection fasteners 184 for joining the leg connection plate 182 to the left and right leg members 110, 112.

Triangular sections 188,190 of the T-shaped section's lower portion may be foldable along the dashed lines A and B to abut left and right portions of the T-shaped section along the left leg member's left side and the right leg member's right side, respectively. Each triangular section 188, 190 may have one or more holes (not shown) for receiving leg connection fasteners 184 for further joining the leg connection plate 182 to the left and right leg members 110, 112. Abutting portions of the T-section to the left and right sides of the left and right leg members 110, 112 and joining these sections 188,190 to the left and right leg members 110, 112 with leg connection fasteners 184 may help to resist the tendency of the leg members 110, 112 to spread apart under the weight of the torso, head, and left and right arm members 102, 104, 106, 108.

A quick release system similar in operation to the one described for the left arm connection assembly 156 may also be used for the leg member connection assembly 180. Easy removal of the leg members 110, 112 from the torso member 102 allows for leg members 110, 112 with different configurations and sizes to be readily attached and detached from a generic torso member 102.

The head fasteners 152, right and left arm member and segment connection fasteners 160, 162, 178, leg connection fasteners 184, and the base fasteners 150 may be nails, screws, bolts, U-bolts, flexible straps, any other suitable mechanical fastener, or any combination thereof. Further, any of these fasteners may be threaded or unthreaded. Threaded fasteners may be useful for readily detaching various members and segments to replace or repair them or to disassemble the stick figure structure 100 for storage or transport. In lieu of or in combination with using fasteners to join any or all of the various members and segments, any of the various members and segments may be joined to other members or segments using welds, adhesives, any other suitable means for joining two items together, or any combination thereof.

With reference to FIGS. 2, 6 and 7, the torso member 102 and the left and right leg members 110, 112 may be any suitable length and may have generally square cross-sectional areas formed by joining two components having generally rectangular cross-section areas. These components may be joined using mechanical fasteners 200 as depicted, by welds, adhesives, any other suitable means for joining components together, or any combination thereof. The left and right arm segments 130, 132 may be any suitable length and may have generally rectangular cross section areas. Although generally square or rectangular cross-section areas are depicted for the various members 102, 106, 108, 110, 112, any of the members 102, 106, 108, 110, 112 (other segments 130, 132, 134, 140, 142, forming the various members 106, 108, 110, 112) could have any suitable cross-sectional area including circular, hexagonal, tubular, and so on. Further, the various members 102, 104, 106, 108, 110, 112 may be integrally formed or may be formed with more or less components than depicted.

The torso member 102, left and right arm members 106, 108, the left and right leg members 110, 112, and the left and right base members 112, 114 may be made of wood, metal, plastic, any other suitable material, or any combination thereof. Wood or other lightweight materials may allow the stick figure structure 100 to be easier to carry and transport when partially or fully assembled. Wood also comes in pre-formed elongated pieces (e.g., a 2×4 board) and is relatively easy to shape at the ends for joining members 102, 106, 108, 110, 112, 114, 116 at various angles to each other. It is also relatively easy to join wood items together using mechanical fasteners and to paint and water-seal wood items.

With reference to FIGS. 1-7, an exemplary method of manufacturing the stick figure structure 100 will now be described. Two 2×4 wood boards approximately 42 inches long may be joined together with one or more mechanical fasteners 200 to form the torso member 102. For each leg member 110, 112, two 2×4 wood board approximately 51 inches long may be joined together with one or more mechanical fasteners 200 to form each leg member. Each leg member 110, 112 may be cut near an end portion to form edges that are approximately flush to edges of either the other leg member 110, 112 or the torso member 102 when joined to the torso member 102 as best shown in FIG. 2. Each leg member 110, 112 may be joined to the torso member 102 near the torso member's lower end portion using the leg member connection assembly 180. When joined to the torso member 102, the leg members 110, 112 may together form a shape that resembles an inverted V with an angle of approximately sixty degrees between them. However, the angle between the leg members 110, 112 may be greater or less than sixty degrees if desired.

One 2×4 wood board approximately 51 inches long may form the left arm member 106. An end portion of the left arm member 106 may be cut at an angle to form a generally flush edge with the torso member 102 as best shown in FIG. 2. The left arm member 106 may be joined to the torso member 102 between its upper and lower end portions using the left arm member connection assembly 156. Two 2×4 wood boards approximately 25 inches long may form upper and lower right arm segments 132, 134 for the right arm member 108. End portions of the upper and lower right arm segments 132, 134 may be cut at angles to form generally flush edges with each other and the torso member 102 as best shown in FIG. 2. The upper right arm segment 132 may be joined to the torso member 102 between the torso member's upper and lower end portions using the right arm member connection assembly 172, and the lower right arm segment 134 may be joined to the upper right arm segment 132 using the right arm segment connection assembly 174. For the head member 104, a bicycle wheel with a diameter of approximately 26 inches may be used. The bicycle wheel may be joined near the torso member's upper end portion by passing one or more head fasteners 152 through the bicycle wheel rim and tire 122, 124 and into the torso member 102.

Each base member 114, 116 may be an approximately two foot wide by two foot long plywood board or any other suitable shape and size. Each base member 114, 116 may be joined with its respective leg member 110,112 with one or more base fasteners 150. When assembled, the stick figure structure 100 may have a height of approximately ten feet. Although a method of manufacturing the stick figure structure 100 has been described with an assembly of parts in a certain order and with certain sizes, shapes, number of components and materials for the members 102, 104, 106, 108, 110, 112, 114, 116, some or all of the steps may be omitted or their order changed to create the stick figure structure 100. Further, the stick figure structure's members 102, 104, 106, 108, 110, 112, 114, 116 may be composed of different materials or may have different sizes, shapes or number of components.

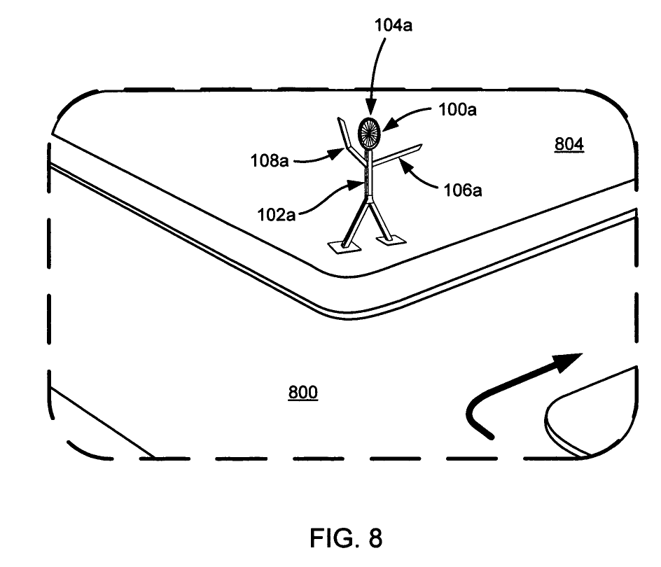

The stick figure structure 100 may be used to convey information about an event or activity to observers of the structure 100, including participants and non-participants of the event or activity, by selectively configuring the arm and leg members 106, 108, 110, 112 and by selecting an appropriate object for the head member 104. For example, FIG. 8 shows a stick figure structure 100a utilized to provide route information for a bicycling event. As shown in FIG. 8, the stick figure structure 100a may have a bicycle wheel for its head member 104a, which readily informs observers of the structure 100a that the stick figure structure 100a is associated with a bicycling event. Further, the stick figure structure's left and right arm members 106a, 108a may be configured to inform observers of the structure 100a to turn right at an intersection 8a rather than proceeding straight. More particularly, the combination of the right arm member 108a (which is formed from two right arm segments) extending generally outward and upward from the torso member 102a and the left arm member 106a extending generally leftward from the torso member 102A informs observers of the stick figure structure 100a to turn right at the intersection. Thus, the combination of an appropriately selected object for the head member 104a with an appropriately selected configuration for the arm members 106a, 108a conveys information to observers of the stick figure structure 100a in a simple and convenient manner.

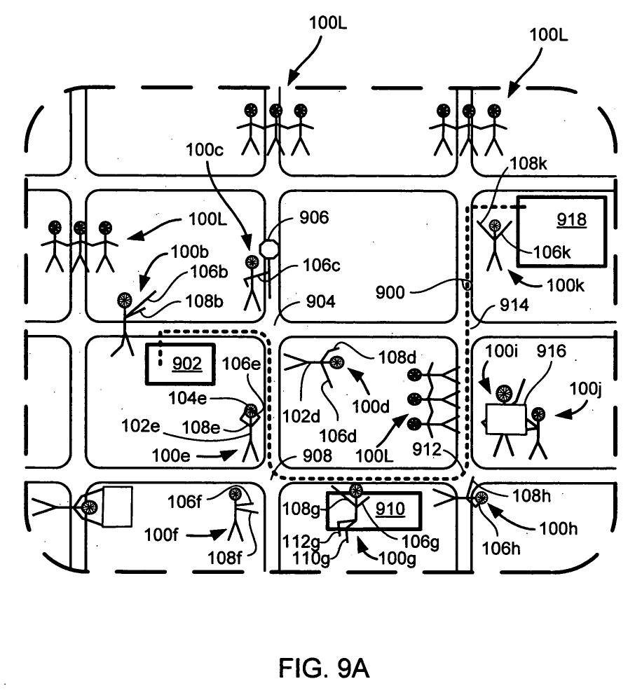

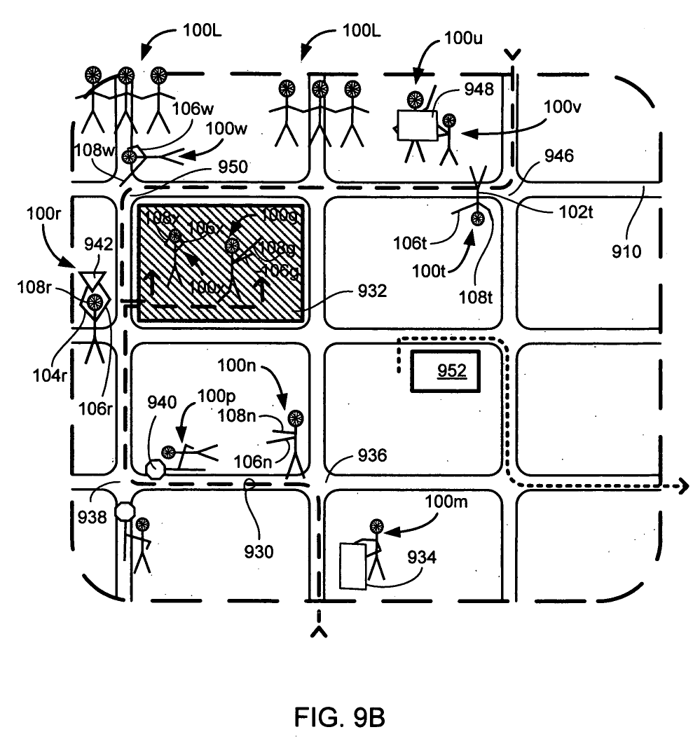

As shown in FIG. 9A, stick figure structures may be arranged along a bicycle course 900 for a bicycle event to convey course directions and other information to participants and other observers of the structures. For example, a first stick figure structure 100b located near a start 902 of the course 900 may be configured to indicate (e.g., both arm members 106b, 108b extending generally to left) that participants should turn right onto the road. A second stick figure structure 100c located near a first intersection 904 of the course 900 may be configured to support from its left arm member 106c a stop sign 906 for indicating to observers in vehicles on the road to stop. A third stick figure structure 100d located near the first intersection 904 along the course 900 may be configured to indicate (e.g., the right arm member 108d extending generally upwards to the right and left arm member 106d extending generally horizontally to the left from the torso member 102d) that participants should turn right at the intersection 904.

Continuing with the example shown in FIG. 9A, a fourth stick figure structure 100e located near a second intersection 908 may be configured to indicate (e.g., both arm members 106e, 108e extending upwards from the torso member 102e and ending near the head member 104e) that participants need to be careful at the intersection 908. A fifth stick figure structure 100f also located near the second intersection 908 of the course 900 may be configured to indicate (e.g., both arm members 106f, 108f extending to the left) that participants should turn left at the intersection 908. A sixth stick figure structure 100g located near a refreshment zone 910 may be configured (e.g., both arm members 106g, 108g extending upwards with the leg members 110g, 112g bent to make it appears as if the structure 100g is sitting) to indicate that the participants are entering the refreshment zone 910.

A seventh stick figure structure 100h located near a third intersection along the course may be configured to indicate (e.g., the right arm member 108h extending generally horizontal to the right and the left arm member 106h extending generally up towards the head member 104h) that participants should turn left at the intersection 912 and may also warn participants that there may be sun glare because they may be riding into the sun. Eight and ninth stick figure structures 100i, 100j located between the third intersection 912 and the fourth intersection 914 may be arranged and configured to support sign 916 between their respective arm members. The sign 916 may provide information such as mileage left to the participants. A tenth stick figure structure 100k located near an end 918 of the course 900 may be configured to indicate (e.g., the arm members 106k, 108k arranged in a touchdown position) that the participants have reached the end 918 of the course 900.

At roads crossing the course 900, at locations along the course 900, or at any other suitable location, two or more stick figures structures 100L may be used to form a barrier for vehicles or the crowd by configuring and aligning them in a manner to resemble the holding of hands by the stick figure structures 100L. The example shown in FIG. 9A and described herein is merely illustrative of how multiple stick figures structures may be used to convey information to an observer of the structures regarding the direction of travel on a course or route, or other information regarding the event, and is not intended to be limiting.

FIG. 9B is similar to FIG. 9A except stick figure structures are arranged to convey information regarding route information to an area associated with an event and other information to observers of the structures. For example, a first stick figure structure 100m located along a first route 930 to the parking area 932 may be configured to support a sign 934 that welcomes observers of the sign 934 to the event. A second stick figure structure 100n located near a first intersection 936 along the first route 930 to the parking area 932 may be configured to indicate (e.g., both arm members 106n, 108n extending towards the right) to those seeking parking for the event that they should turn left at the intersection 936. A third stick figure structure 100p located near a second intersection 938 along the first route 930 to the parking area 932 may be configured to support a stop sign 940 to indicate that traffic on the route 930 should stop before entering the intersection 938. A fourth stick figure structure 100r located on the first route 930 near the parking area 932 may be configured to support with its arm members 106r, 108r a yield sign 942 above its head member 104r to indicate to traffic approaching the parking area 932 to yield to traffic turning into the parking area 932 from a second route 944.

Continuing with the example shown in FIG. 9B, a fifth stick figure structure 100t located near a first intersection 946 along the second route 944 may be configured to indicate (e.g., the right arm member 108t extending generally upwards to the right and left arm member 106t extending generally horizontally to the left from the torso member 102t) to those seeking parking for the event that they should turn right at the intersection 946. Sixth and seventh stick figure structures 100u, 100v located near the first intersection 946 along the second route 944 may be configured to support between their respective arm members a sign 948 that welcomes observers of the sign 948 to the event. An eighth stick figure structure 100w located near a third intersection 950 along the second route 944 to the parking area 932 may be configured to indicate (e.g., the left arm member 106w extending generally bent and extending upwards and the right arm member 108w extending generally to the right) to those seeking parking for the event that they should turn left at the intersection 950.

A ninth stick figure structure 100x located within the parking area 932 may be configured to indicate (e.g., both arm members 106x, 108x extending upward and ending near the head member 104x) to be careful in the parking area 932. A tenth stick figure structure 100y also located within the parking area 932 may be configured to indicate (e.g., both arm members 106y, 108y extending towards the left) that cars should continue past the structure 100y before parking in a parking space.

Access to an area associated with the event along non-preferred routes may also be closed by arranging two or more stick figure structures 100L to form a barrier across one or more roads as described above. Further, any or all stick figure structures arranged along a route to convey information to an observer of the stick figure may support a sign or other object if desired. The example shown in FIG. 9B and described herein is merely illustrative of how multiple stick figures structures may be used to convey information to an observer of the structures regarding the direction of travel to locations associated with the event or other information regarding the event and is not intended to be limiting.

Stick figure structures may also convey information to non-participants observers or other observers of the structures about an activity or event. For example, it may be infeasible to close every intersection that a bicycling event may cross or to close every road on a cycling path. In such a situation, vehicles and bicycles may cross paths. Relatively large stick figure structures, for example stick figures having a height of at least approximately six feet or taller, may be located on roads crossing over or near the course to provide an easy to remember warning to motorists to be observant for cyclists. Continuing with the example, the stick figure structures may be configured to hold a stop sign (or appear to hold a stop sign ), or have their arm members configured to indicate a stop signal (e.g., both arm members having upper arm segments extending outwards towards the front side of the structure and lower arm segments extending vertically upwards), at an road or intersection crossing a bicycle route to remind motorists to watch out for cyclists or stop for cyclists and/or to inform or remind motorists that a bicycling event is occurring nearby. More particularly, using a bicycle wheel for the head member provides an indication to the motorist that the stick figure structure is associated with a bicycle path or event. Further, the size of the stick figure structure combined with the stick figure structure holding (or conveying via its arm member arrangement or other configuration) information that the motorist should stop and check for cyclists conveys information to the motorist in a simple and easy to remember manner.

As yet another example and in manner similar to the one described above with reference to FIG. 9B, stick figure structures may be arranged along a road to provide directions to participants, spectators, or other observers about how to reach gathering areas such as parking areas, staging areas, meeting areas, or the like, or other areas associated with an event or to block access to the area along certain routes. Again, using a bicycle wheel (or other suitable object related to an event) for the head member informs a participant, a spectator, or another observer that the stick figure structure is associated with a bicycling event (or other event), and appropriate configuration of the arm members or other appropriate members of the stick figure structure provides direction information. As still yet another example, the stick figure structures may be arranged around the roads near an event to indicate to motorists directions to proceed to avoid the event. More particularly, the stick figure structures may be located at intersections and configured to point to the direction to proceed to encounter the event, thereby informing motorists the direction or directions to go to avoid the event.

As yet still another example, stick figure structures may be posted in trees or other objects on trails used by bicycles to indicate to observers of the structures that the bicycles may travel on the trail. These stick figure structures may also be configured to convey to observers of these structures the direction to proceed on the trail or convey other information such as to watch out for bicyclists or stop.

Stick figure structures may be any size. However, compared to smaller stick figures structures, larger stick figure structures generally stand out more from their environment and convey information to observers at a greater distance from the stick figure structure. Accordingly, stick figure structures may range from approximately six feet to twelve feet tall although stick figure structures may be smaller or taller if desired. For example, a stick figure structure of approximately two to four feet tall may be used to indicate that the structure resembles a child or supports a sign providing information pertaining to children. As another example, stick figure structures aligned to form a barrier for separating spectators from participants may be approximately three feet or so tall to allow spectators to see over the stick figure structures. As yet another example, a stick figure structure for posting on an object such as a tree near a trail used by bicyclists may be approximately one foot or so.

The size of stick figure structures proximate each other may be varied to indicate one stick figure structure represents an adult and another a child. This may be useful when an event or activity involves both adults and children, or when an event has areas certain areas for specific groups such as families or adults only.

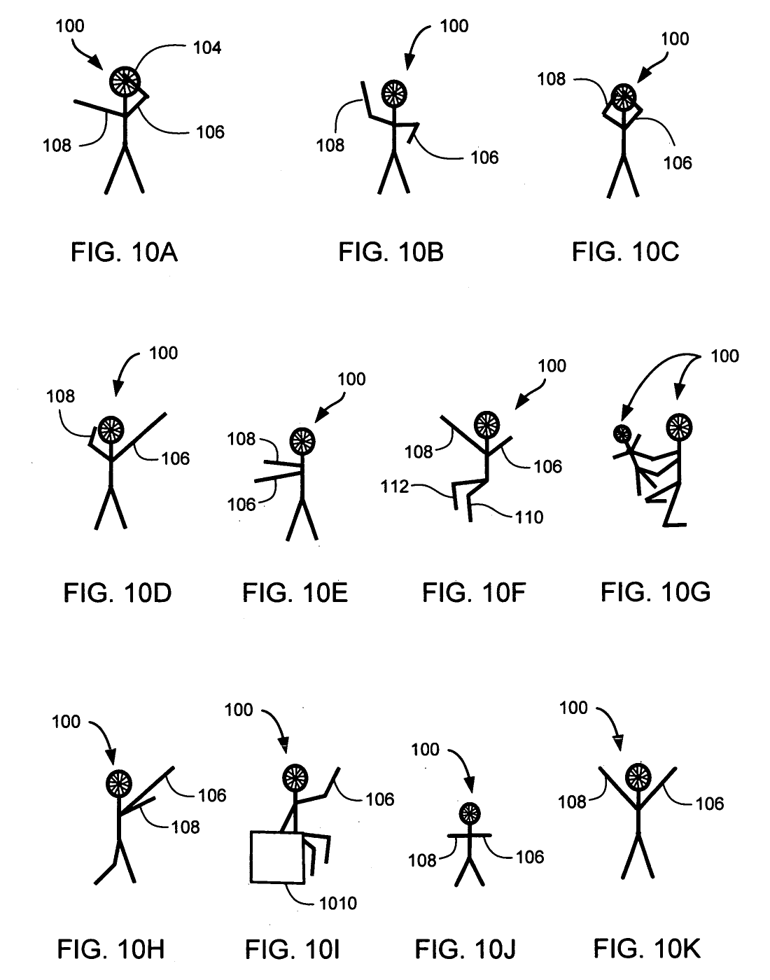

FIGS. 10A-I depict some examples of various ways stick figure structures may be configured to convey information to an observer of a stick figure structure. As shown in FIG. 10A, a stick figure structure's right arm member 108 may extend generally towards the right and a left arm member 106 may be bent towards the head member 104 to convey to an observer of the structure 100 a direction to proceed or that eye protection such as sunglasses may be required to shield the eyes from sun glare since the observers will be proceeding into the sun. As shown in FIG. 10B, a stick figure structure's right arm member 108 may be bent upward and a left arm member 106 may be bent downward to make it appear as if the structure 100 is waving its arm members 106, 108 to convey to an observer of the structure 100 a greeting such as hello or goodbye. As shown in FIG. 10C, a stick figure structure's right and left arm members 106, 108 may both be bent towards the head member 104 to make it appear as if the structure 100 is covering its eyes to convey to an observer of the structure 100 to watch out or danger ahead.

As shown in FIG. 10D, a stick figure structure's right arm member 108 may be bent upward and the left arm member 106 may slope steeply to the left and upward to convey to an observer of the structure 100 to go uphill, that a hill is coming up, or to keep an eye out for falling objects. As shown in FIG. 10E, a stick figure structure's right and left arm members 106, 108 may both extend towards the right to convey to an observer of the structure 100 to move to a certain side or to go a location that the arms 106, 108 point to and wait. As shown in FIG. 10F, a stick figure's right arm member 108 may extend to the right and upward, the left arm member 106 may extend to the left and upward, and the leg members 110, 112 may be bent to make it appear as if the stick figure structure 100 is sitting to convey to an observer of the structure 100 a direction to proceed to a rest area or that the observer has reached a rest area, a place to sit, or a refreshment area.

As shown in FIG. 10G, a stick figure structure 100 may be configured to form a kneeling position and may be further configured to hold a smaller stick figure structure to convey to an observer of the structure 100 that help or medical assistance is available here. As shown in FIG. 10H, a stick figure structure's left and right arms 106, 108 may both extend to the left to convey to an observer of the structure 100 a direction to proceed. As shown in FIG. 10I, a stick figure structure 100 may be configured to appear to sit on a box 1010 and it's left arm member 106 may be bent upward to convey to an observer of the structure 100 that there is a sign nearby that should be read.

As shown in FIG. 10J, both of a stick figure structure's arm members 106, 108 may extend generally horizontally from the torso member 102 in opposite directions to convey to an observer of the structure 100 that the observer should slow down, stop, shut down the observer's vehicle, or form an even line of cars in a parking area. As shown in FIG. 10K, a stick figure structure's arm members 106, 108 may both extend upward to form a V shaped to convey to an observer of the structure 100 that the observer has reached an end or finish area. These examples are merely illustrative of some possible configurations for the stick figure structure and are not intended to be limiting.

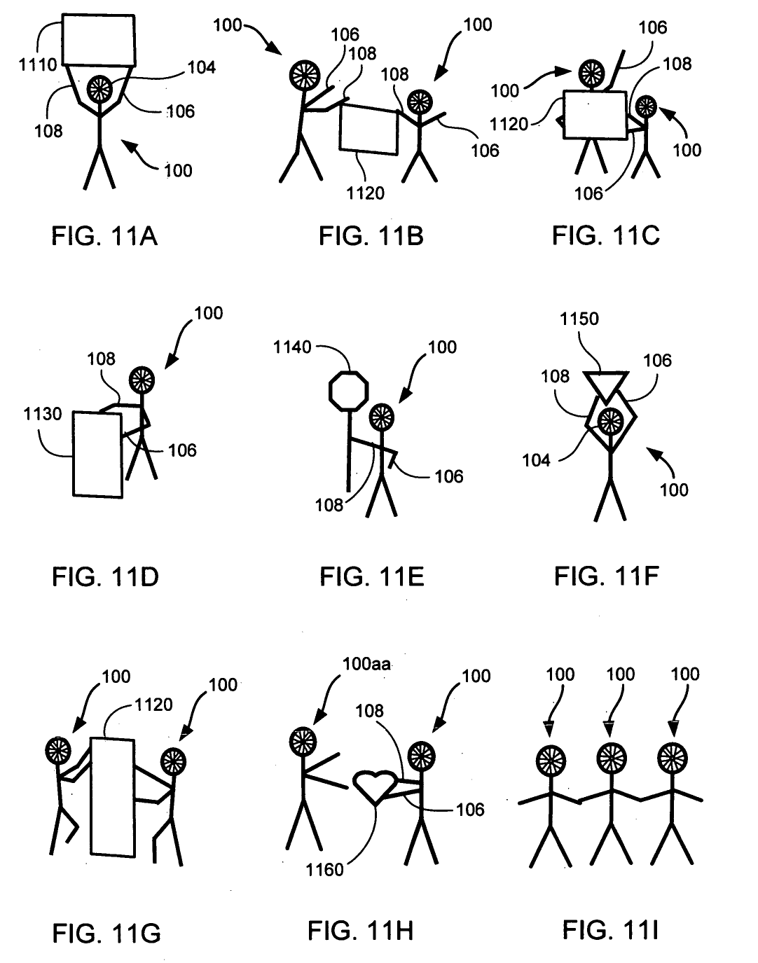

With reference to FIGS. 11A-I, stick figure structures may also be configured to support banners, signs or other objects conveying written or other information. Further, two or more stick figure structures may be configured and arranged to jointly support banners, signs, or other objects conveying information. As shown in FIG. 11A, a stick figure structure's left and right arm members 106, 108 may be configured to hold a sign 1110 above its head member 104. Holding the sign 1110 above the head member 104 conveys to the observer of the structure 100 that the sign 1110 contains important information to read. As shown in FIGS. 11B, 11C and 11G, two stick figure structures 100 may be configured and arranged to support a sign 1120 between their arm members 106, 108. With respect to FIGS. 11B and 11C, the combination of the relatively large and relatively small structures 100 conveys to an observer of the structures 100 that the information on the sign 1120 concerns children.

As shown in FIG. 11D, a stick figure structure's left and right arm members 106, 108 may be configured to support a sign 1130 on the stick figure structure's right side. Supporting a sign 1130 to a side of the structure 100, either the left or the right side, may allow a generally larger sign 1130 to be used. A larger sign 1130 may be desired to indicate that the sign 1130 is important or to use larger letter sizes. As shown in FIG. 11E, a stick figure structure's right arm member 108 may be configured to support a stop sign 1140 on the stick figure structure's right side in a manner similar to a road construction crew. As shown in FIG. 11F, a stick figure structure's left and right arm members 106, 108 may be configured to support a yield sign 1150 or other recognized sign above the stick figure structure's head member 104.

As shown in FIG. 11H, a first stick figure structure's left and right arm members 106, 108 may be configured to hold a heart shaped object 1160 or other recognized shape on the stick figure structure's right side and another stick figure structure 100aa may be configured near the first stick FIG. 100 as if receiving the heart shaped object 1160 or other object to convey to an observer of the structures 100, 100aa that the observer has reached an awards area. As shown in FIG. 11I, two or more stick figure structures 100 may be configured and arranged to appear as if each is holding the hand of an adjacent stick figure structure 100 to form a barrier or a barricade. Barriers or barricades may be used to block roads and trails, for crowd control, to surround award areas, to form a pathway, and so on. These examples are merely illustrative of some possible configurations for a stick figure structure or structures to support a sign, banner, or other object conveying written or other information and are not intended to be limiting.

Signs, banner, and other objects conveying written or other information to an observer may be supported by one or more stick figure structures using any suitable means for supporting an object using a structure. As an example and with reference to FIG. 12, the stick figure structure 100 may include one or more clips, eye bolts or the like 1202 joined to an arm member 108. Wires, ropes or the like 1204 connected with a sign 1206 may be connected with the clips, eye bolts or the like 1202 to support the sign 1206 from the stick figure structure 100. If desired, the clips, eye bolts, or the like 1202 may be omitted, and the wires, ropes or the like 1204 may be directly tied or other attached to the stick figure structure 100. The example for joining a sign, banner, and other object to the stick figure structure depicted in FIG. 12 and described herein is merely exemplary of one possible way to support a sign, banner or other object using a stick figure structure and is not intended to be limiting. According, any suitable device or method for supporting an object with a structure may be used to support a sign, banner, or other object using one or more stick figure structures. Further, the sign, banner, or other object may be supported from one or more of any of the stick figure structure's torso, arm, leg, or base members 102, 106, 108, 110, 112, 114, 116.

Stick figure structures may also be painted or colored a select color or colors to further convey information to an observer. For example, a stick figure structure 100 may be painted yellow to indicate caution. As another example, as stick figure structure 100 used for an event like a ride for the cure for breast cancer may be painted pink to further indicate to observers of the structure 100 that the stick figure structure 100 is associated with this event. As yet another example, a stick figure structure 100 used for an Olympic cycling event may be painted with the logos used by the host city or with the Olympic rings to further indicate to an observer that the stick figure structure 100 is associated with the event. These examples are merely exemplary of some possible ways a stick figure structure 100 may be colored to convey information to an observer of the stick figure structure 100 that further associates the stick figure structure 100 with a specific event or activity.

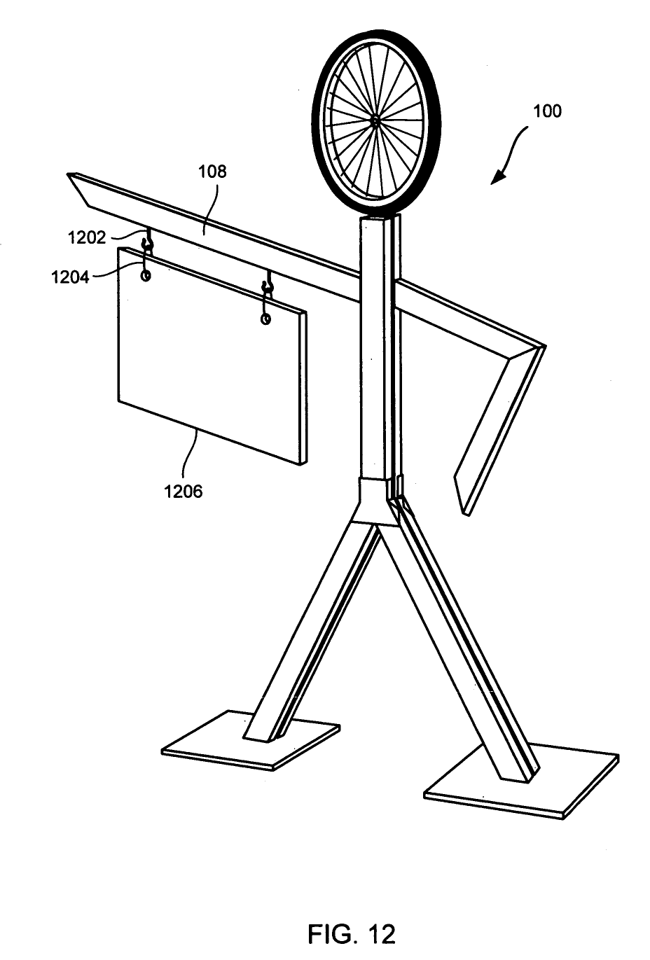

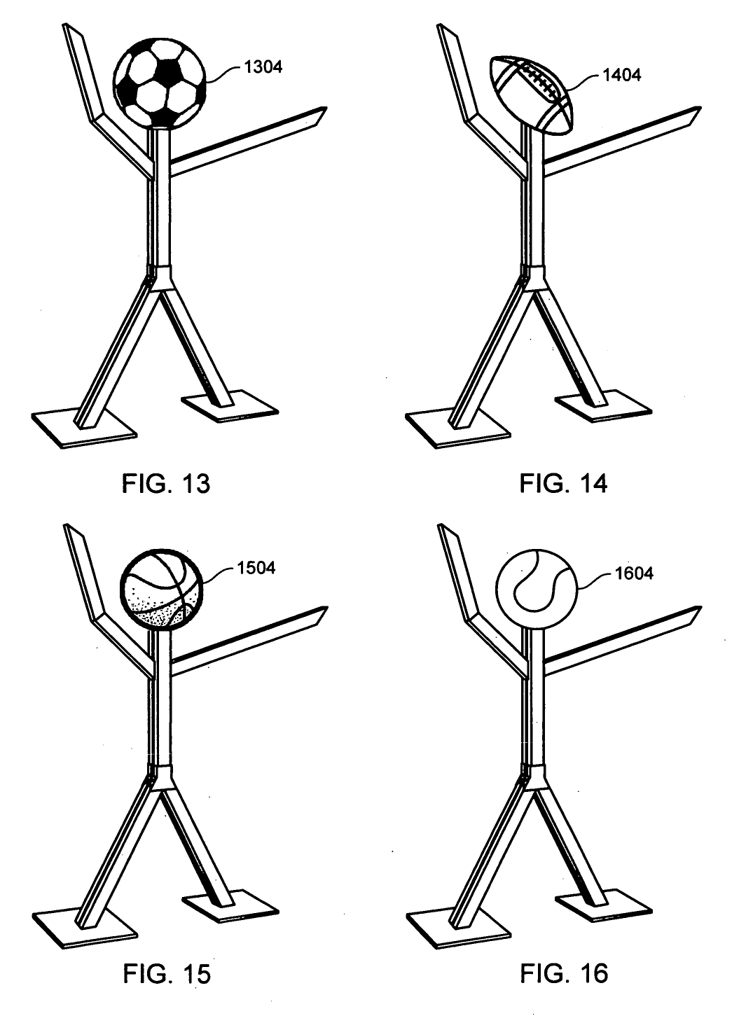

Although stick figure structures have been described as being used in connection with bicycling or bicycling events, stick figure structures may be used for any suitable activity or event. For example, stick figure structures may be used in connection with a soccer event. When used with a soccer event, the object used for head member 1304 may be a soccer ball or an object resembling a soccer ball rather than a bicycle wheel as shown in FIG. 13. As described above with respect to using a bicycle wheel for the head member in connection with bicycling or a bicycling event, using an object related to the event or activity for the head member conveys to an observer of the stick figure structure that the stick figure structure is associated with the event or activity. Possible uses for stick figure structures at a soccer event may include placing the structures along roads to provide directions to parking or other areas (e.g., the soccer stadium or field) associated with the event, supporting sponsor's banners or signs with stick figure structures at sites near or in the soccer field or stadium, supporting signs or other objects that provide information to spectators, and so on.

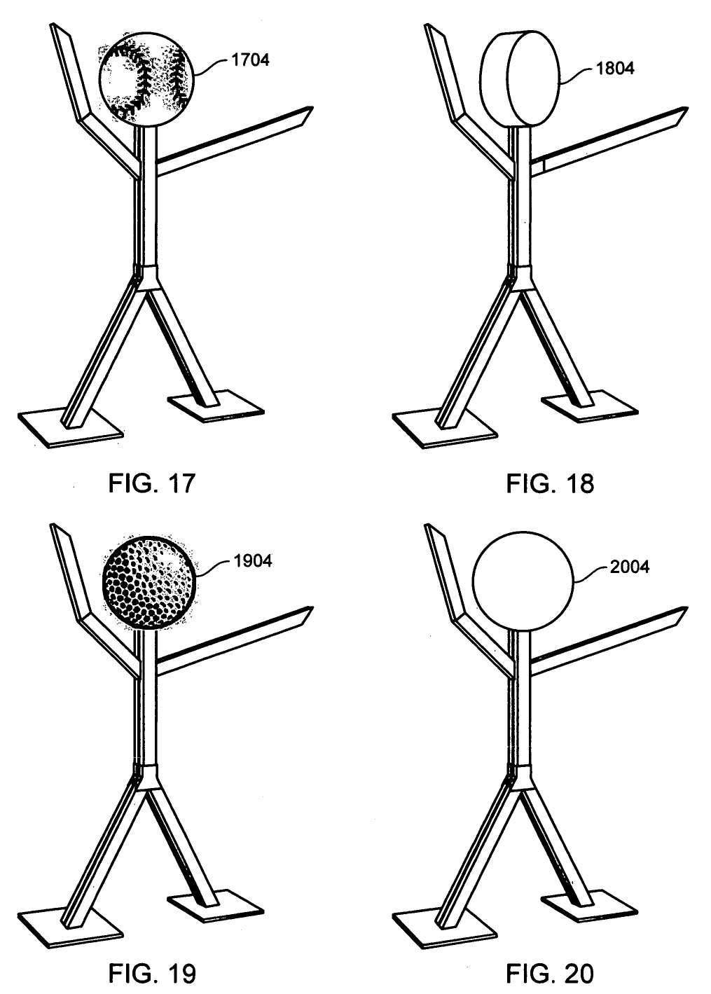

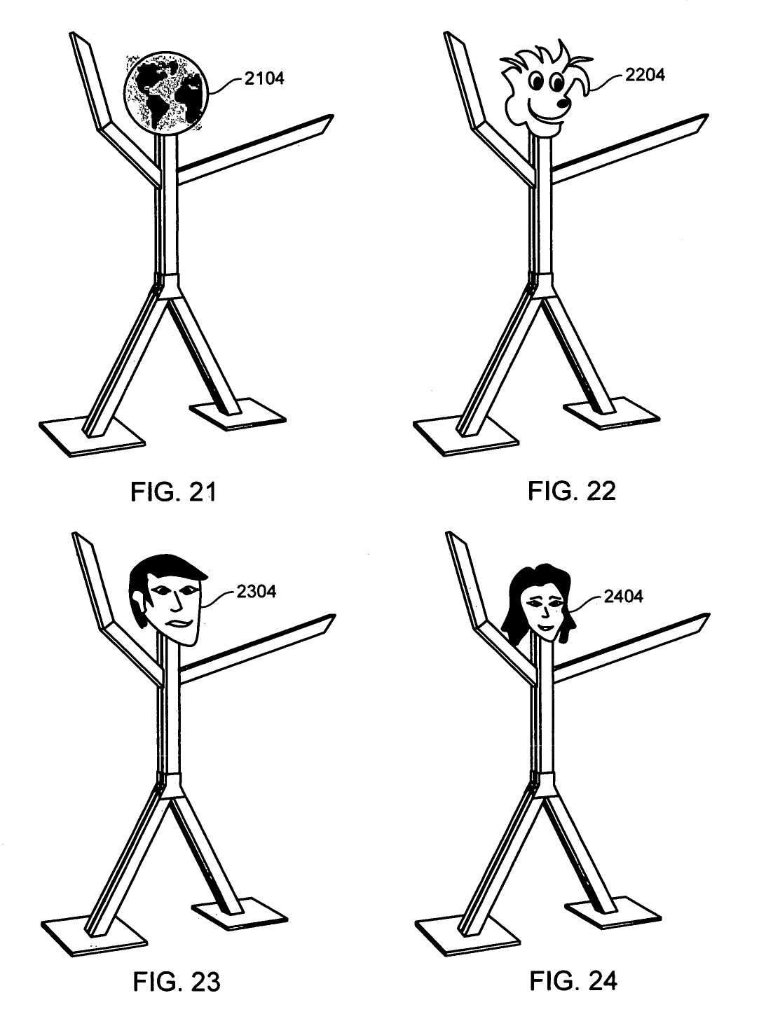

As other non-limiting examples, stick figure structures may be used at football events, basketball events, tennis events, baseball events, hockey events, golf events, music concerts, political events, outdoor events and so on. For a football event, a football or and object resembling a football may be used for the head member 1404 as shown in FIG. 14. For a basketball event, a basketball or an object resembling a basketball may be used for the head member 1504 as shown in FIG. 15. For a tennis event, a tennis ball or an object resembling a tennis ball may be used for the head member 1604 as shown in FIG. 16. For a baseball or softball event, a baseball, a softball or an object resembling a baseball or a softball may be used for the head member 1704 as shown in FIG. 17. For a hockey event, a hockey puck or an object resembling a hockey puck may be used for the head member 1804 as shown in FIG. 18. For a golf event, a golf ball or an object resembling a golf ball may be used for the head member 1904 as shown in FIG. 19. For a school field day, a generic ball or an object representing a generic ball may be used for the head member 2004 as shown in FIG. 20. For an environmental or global awareness event, a globe or an object resembling a globe may be used for the head member 2104 as shown in FIG. 21. For an event involving animals, cartoon characters, or an event with a mascot such as a school mascot or a company mascot, an object resembling an animal, cartoon character, or mascot head may be used for the head member 2204 as shown in FIG. 22. For a political event such a political rally or convention, an object representing a male or a female head may be used for the head member 2304, 2404 as shown in FIGS. 23 and 24. For a music concert, a music instrument such as a drum or an object resembling a music instrument may be used for the head member. In short, stick figure structures may be used at any event or for any activity, and any suitable object related to the event or activity may be used for the head member.

The examples of configurations for stick figure structure and the possible environments for their use that are set forth herein are merely exemplary of some ways to use stick figure structures to convey information to observers and are not intended to be limiting. All directional references (e.g., upper, lower, upward, downward, left, right, leftward, rightward, top, bottom, above, below, vertical, horizontal, clockwise, and counterclockwise) are only used for identification purposes to aid the reader's understanding of the examples of the present invention, and do not create limitations, particularly as to the position, orientation, or use of the invention unless specifically set forth in the claims. Joinder references (e.g., attached, coupled, connected, joined, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Changes in detail or structure may be made without departing from the spirit of the invention as defined in the appended claims. Accordingly the matter contained in the above description or shown in the accompanying drawings shall be interpreted as illustrative only and not limiting.

1. A structure for conveying information about a specific event or activity to an observer of the structure comprising:
a torso member including a first end portion and a second end portion;
a head member joined with the torso member near the first end portion of the torso member;
at least one arm member joined with the torso member between the first and second end portions of the torso member and extending from the torso member; and
at least one leg member joined with the torso member near the second end portion of the torso and extending from the torso member; wherein
the head member is an object related to the specific event or activity; and
the head member, the torso member, the at least one arm member, and the at least one leg member are configured to resemble a stick figure.

2. The structure of claim 1, wherein the specific event or activity relates to bicycling and the head member is a bicycle wheel including at least one spoke.

3. The structure of claim 2, wherein the specific event or activity is a bicycling event.

4. The structure of claim 1, wherein:
the event or activity relates to one of a group consisting of soccer, tennis, golf, basketball, baseball, softball, football, and hockey; and
the head member is a soccer ball or an object resembling a soccer ball if the event or activity relates to soccer;
the head member is a tennis ball or an object resembling a tennis ball if the event or activity relates to tennis;
the head member is a golf ball or on object resembling a golf ball if the event or activity relates to golf;
the head member is a basketball or an object resembling a basketball if the event or activity relates to basketball;
the head member is a baseball or an object resembling a baseball if the event or activity relates to baseball;
the head member is a softball or an object resembling a softball if the event or activity relates to softball;
the head member is a football or an object resembling a football if the event or activity relates to football; and
the head member is a hockey puck or an object resembling a hockey puck if the event or activity relates to hockey.

5. The structure of claim 1, wherein the torso member, the at least one arm member, and the at least one leg member are further configured to convey to the observer of the structure at least one of a group consisting of a direction to proceed, hill ahead, danger ahead, rest area, medical area, welcome, and goodbye.

6. The structure of claim 1 further comprising a sign providing at least written information and supported by the structure.

7. The structure of claim 6, wherein the sign is supported by the at least one arm member.

8. The structure of claim 1 further comprising at least one base member joined to the at least one leg member.

9. The structure of claim 8, wherein the at least one base member is operatively associated with a support surface.

10.-19. (canceled)

20. The structure of claim 1, wherein the torso member comprises an elongated member including a substantially rectangular cross-section between the first and second end portions.

21. The structure of claim 1, wherein the torso member is a single elongated member.
